(19) United States
(12) Patent Application Publication
(10) Pub. No.: US 2008/0071770 A1
(43) Pub. Date: Mar. 20, 2008

(54) Method, Apparatus and Computer Program Product for Viewing a Virtual Database Using Portable Devices

(75) Inventors: Philipp Schloter, San Francisco, CA (US); Matthias Jacob, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/855,419

(22) Filed: Sep. 14, 2007

Related U.S. Application Data
(60) Provisional application No. 60/825,929, filed on Sep. 18, 2006.

(51) Int. Cl. G06F 17/30

(52) U.S. Cl. 707/5; 707/3; 707/E17.014

(57) ABSTRACT

An apparatus for combining a visual search system(s) with a virtual database to enable information retrieval may include a processing element. The processing element may be configured to receive an indication of an image including an object, provide a tag list associated with the object in the image, the tag list comprising at least one tag, receive a selection of a keyword from the tag list, and provide supplemental information based on the selected keyword.

### CROSS-REFERENCE TO RELATED APPLICATIONS

The present application claims priority to U.S. Provisional Application No. 60/825,929 filed Sep. 18, 2006, the contents of which are incorporated by reference herein in their entirety.

### FIELD OF THE INVENTION

Embodiments of the present invention generally relates to mobile visual search technology and, more particularly, relate to methods, devices, mobile terminals and computer program products for combining a visual search system(s) with a virtual database to enable information retrieval.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demands, while providing more flexibility and immediacy of information transfer.

Current and future networking technologies continue to facilitate ease of information transfer and convenience to users. One area in which there is a demand to increase ease of information transfer and convenience to users relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, video recorders, cameras, etc, or even from a combination of the mobile terminal and the network device. In this regard, various applications and software have been developed and continue to be developed in order to give the users robust capabilities to perform tasks, communicate, entertain themselves, gather and/or analyze information, etc. in either fixed or mobile environments.

With the wide use of mobile phones with cameras, camera applications are becoming popular for mobile phone users. Mobile applications based on image matching (recognition) are currently emerging and an example of this emergence is mobile visual searching systems. Currently, there are mobile visual search systems having various scopes and applications. However, the main barrier to the increased adoption of mobile information and data services remains the difficult and inefficient user-interface (UI) of the mobile devices that may execute the applications. The mobile devices are sometimes unusable or at best limited in their utility for information retrieval due to a difficult and limited user interface.

There have been many approaches implemented for making mobile devices easier to use including, for example automatic dictionary for typing text with a number keypad, voice recognition to activate applications, scanning of codes to link information, foldable and portable keypads, wireless pens that digitize handwriting, mini-projectors that project a virtual keyboard, proximity-based information tags and traditional search engines, etc. Each of the approaches have shortcomings such as increased time for typing longer text or words not stored in the dictionary, inaccuracy in voice recognition systems due to external noise or multiple conversations, limited flexibility in being able to recognize only objects with codes and within a certain proximity to the code tags, extra equipment to carry (portable keyboard), training the device for handwriting recognition, reduction in battery life, etc.

Given the ubiquitous nature of cameras, such as in mobile terminal devices, there may be a desire to develop a visual searching system providing a user friendly user interface (UI) so as to enable access to information and data services.

### BRIEF SUMMARY OF THE INVENTION

Systems, methods, devices and computer program products of the exemplary embodiments of the present invention for combine a visual search system(s) with a virtual database to enable information retrieval. These designs enable the integration of a visual search system with an information storage system and an information retrieval system so as to provide a unified information system. The unified information system of the present invention can offer, for example, encyclopedia functionality, tour guide of a chosen point-of-interest (POI) functionality, instruction manual functionality, language translation and dictionary functionality, and general information functionality including book titles, company information, country information, medical drug information, etc., for use in mobile and other applications.

One exemplary embodiment of the present invention includes a method comprising receiving an indication of an image including an object, providing a tag list comprising at least one tag and associated with the object in the image, receiving a selection of a keyword from the tag list; and providing supplemental information based on the keyword.

In another exemplary embodiment, a computer program product is provided. The computer program product includes at least one computer-readable storage medium having computer-readable program code portions stored therein. The computer-readable program code portions include first, second, third and fourth executable portions. The first executable portion is for receiving an indication of an image including an object. The second executable portion is for providing a tag list associated with the object in the image. The third executable portion is for receiving a selection of a keyword from the tag list. The fourth executable portion is for providing supplemental information based on the keyword.

Another exemplary embodiment of the present invention includes an apparatus comprising a processing element configured to receive an indication of an image including an object, provide a tag list comprising at least one tag and associated with the object in the image, receive a selection of a keyword from the tag list; and provide supplemental information based on the keyword. Embodiments of the present invention may not require the user to describe a search in words and, instead, taking a picture (or aiming a camera at an object to place the object within the camera's field of view) and a few clicks (or even no click at all, referred to as “zero-click”) can be sufficient to complete a search based on selected keywords from the tag list associated with an object in the picture and provide corresponding supplemental information. The term “click” used herein refers to any user operation for requesting information such as clicking a button, clicking a link, pushing a key, pointing a pen, finger or some other activation device to an object on the screen, or manually entering information on the screen.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a unified mobile information system according to an exemplary embodiment of the present invention;

FIG. 2 is a schematic block diagram of a wireless communications system according to an exemplary embodiment of the present invention;

FIG. 3 is a schematic block diagram of a mobile visual search system according to an exemplary embodiment of the present invention;

FIG. 4 is a schematic block diagram of a virtual search server and search database according to an exemplary embodiment of the present invention;

FIG. 5 is a schematic block diagram of system architecture according to the exemplary embodiment of the invention; and

FIG. 6 is a flowchart for a method of operation to enable information retrieval from a virtual database of mobile devices according to an embodiment of the invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

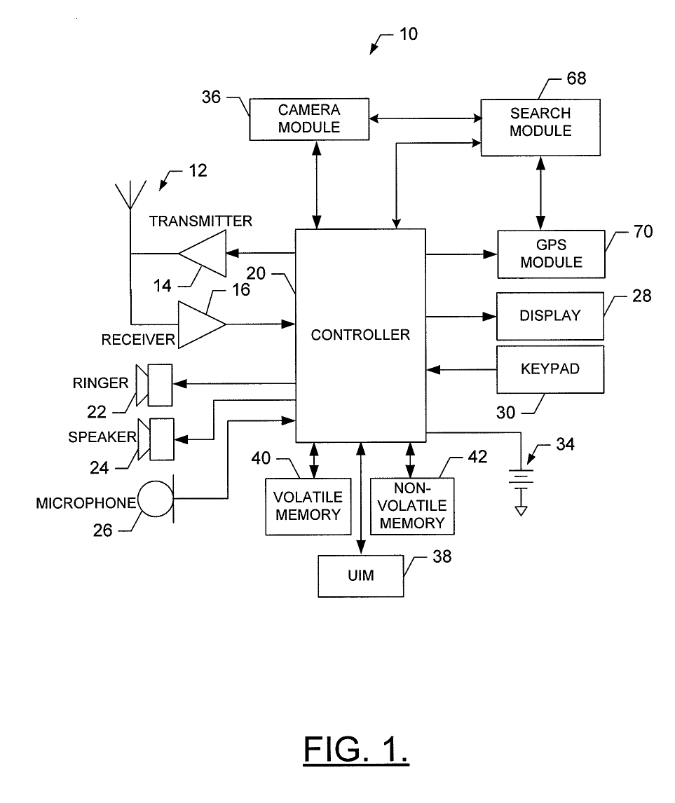

FIG. 1 illustrates a block diagram of a mobile terminal (device) 10 that would benefit from the present invention. It should be understood, however, that a mobile terminal as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDA's), pagers, mobile televisions, laptop computers and other types of voice and text communications systems, can readily employ the present invention. Furthermore, devices that are not mobile may also readily employ embodiments of the present invention.

In addition, while several embodiments of the method of the present invention are performed or used by a mobile terminal 10, the method may be employed by devices other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols including IS-136 (TDMA), GSM, and IS-95 (CDMA), third-generation (3G) wireless communication protocol including Wideband Code Division Multiple Access (WCDMA), Bluetooth (BT), IEEE 802.11, IEEE 802.15/16 and ultra wideband (UWB) techniques. The mobile terminal further may be capable of operating in a narrowband networks including AMPS as well as TACS.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a camera module 36 in communication with the controller 20. The camera module 36 may be any means for capturing an image or a video clip or video stream for storage, display or transmission. For example, the camera module 36 may include a digital camera capable of forming a digital image file from an object in view, a captured image or a video stream from recorded video data. The camera module 36 may be able to capture an image, read or detect bar codes, as well as other code-based data, OCR data and the like. As such, the camera module 36 includes all hardware, such as a lens, sensor, scanner or other optical device, and software necessary for creating a digital image file from a captured image or a video stream from recorded video data, as well as reading code-based data, OCR data and the like. Alternatively, the camera module 36 may include only the hardware needed to view an image, or video stream while memory devices 40, 42 of the mobile terminal 10 store instructions for execution by the controller 20 in the form of software necessary to create a digital image file from a captured image or a video stream from recorded video data. In an exemplary embodiment, the camera module 36 may further include a processing element such as a co-processor which assists the controller 20 in processing image data, a video stream, or code-based data as well as OCR data and an encoder and/or decoder for compressing and/or decompressing image data, a video stream, code-based data, OCR data and the like. The encoder and/or decoder may encode and/or decode according to a JPEG standard format, and the like. Additionally, or alternatively, the camera module 36 may include one or more views such as, for example, a first person camera view and a third person map view.

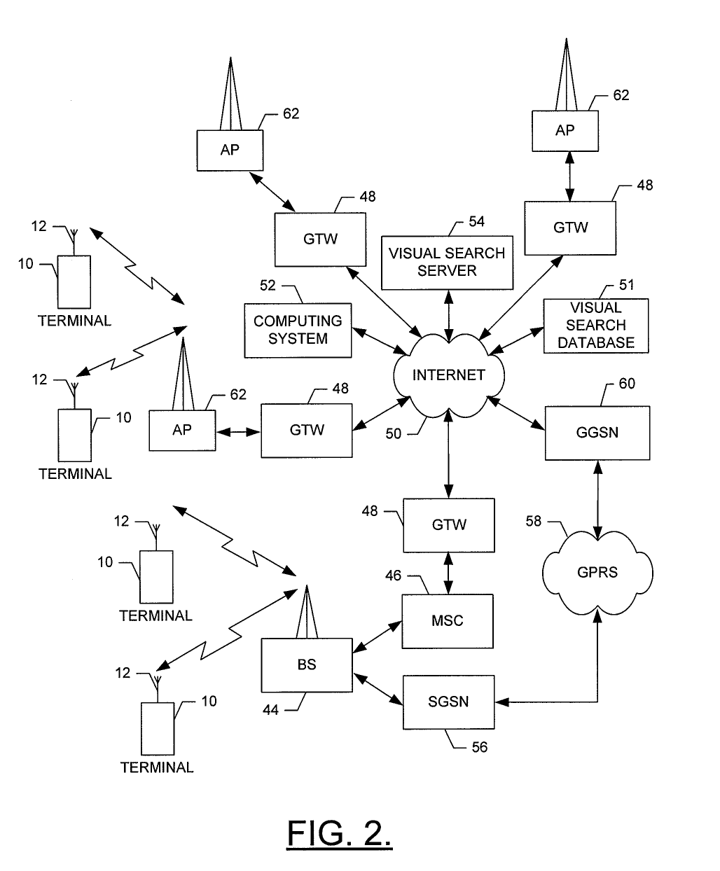

The mobile terminal 10 may further include a GPS module 70 in communication with the controller 20. The GPS module 70 may be any means for locating the position of the mobile terminal 10. Additionally, the GPS module 70 may be any means for locating the position of point-of-interests (POIs), in images captured or read by the camera module 36, such as for example, shops, bookstores, restaurants, coffee shops, department stores, products, businesses, museums, historic landmarks etc. and objects (devices) which may have bar codes (or other suitable code-based data). As such, points-of-interest as used herein may include any entity of interest to a user, such as products, other objects and the like and geographic places as described above. The GPS module 70 may include all hardware for locating the position of a mobile terminal or POI in an image. Alternatively or additionally, the GPS module 70 may utilize a memory device(s) 40, 42 of the mobile terminal 10 to store instructions for execution by the controller 20 in the form of software necessary to determine the position of the mobile terminal or an image of a POI. Additionally, the GPS module 70 is capable of utilizing the controller 20 to transmit/receive, via the transmitter 14/receiver 16, locational information such as the position of the mobile terminal 10, the position of one or more POIs, and the position of one or more code-based tags, as well OCR data tags, to a server, such as the visual search server 54 and the visual search database 51, as disclosed in FIG. 2 and described more fully below.

The mobile terminal may also include a search module such as search module 68. The search module may include any means of hardware and/or software, being executed by controller 20, (or by a co-processor internal to the search module (not shown)) capable of receiving data associated with points-of-interest, code-based data, OCR data and the like (e.g., any physical entity of interest to a user) when the camera module of the mobile terminal 10 is pointed at (zero-click) POIs, code-based data, OCR data and the like or when the POIs, code-based data and OCR data and the like are in the line of sight of the camera module 36 or when the POIs, code-based data, OCR data and the like are captured in an image by the camera module. In an exemplary embodiment, indications of an image, which may be a captured image or merely an object within the field of view of the camera module 36, may be analyzed by the search module 68 for performance of a visual search on the contents of the indications of the image in order to identify an object therein. In this regard features of the image (or the object) may be compared to source images (e.g., from the visual search server 54 and/or the visual search database 51) to attempt recognition of the image. Tags associated with the image may then be determined. The tags may include context metadata or other types of metadata information associated with the object (e.g., location, time, identification of a POI, logo, individual, etc.). One application employing such a visual search system capable of utilizing the tags (and/or generating tags or a list of tags) is described in U.S. application Ser. No. 11/592,460, entitled “Scalable Visual Search System Simplifying Access to Network and Device Functionality,” the contents of which are hereby incorporated herein by reference in their entirety.

The search module 68 (e.g., via the controller 20 in embodiments in which the controller 20 includes the search module 68) may further be configured to generate a tag list comprising one or more tags associated with the object. The tags may then be presented to a user (e.g., via the display 28) and a selection of a keyword (e.g., one of the tags) associated with the object in the image may be received from the user. The user may “click” or otherwise select a keyword, for example, if he or she desires more detailed (supplemental) information related to the keyword. As such, the keyword may represent an identification of the object or a topic related to the object, and selection of the keyword according to embodiments of the present invention may provide the user with supplemental information such as, for example, an encyclopedia article related to the selected keyword. For example, the user may just point to a POI with his or her camera phone, and a listing of keywords associated with the image (or the object in the image) may automatically appear. In this regard, the term automatically should be understood to imply that no user interaction is required in order to the listing of keywords to be generated and/or displayed. If the user desires more detailed information about the POI the user may make a single click on one of the keywords and supplemental information corresponding to the selected keyword may be presented to the user. The search module may be responsible for controlling at least some of the functions of the camera module 36 such as one or more of camera module image input, tracking or sensing image motion, communication with the search server for obtaining relevant information associated with the POIs, the code-based data and the OCR data and the like as well as the necessary user interface and mechanisms for displaying, via display 28, or annunciating, via the speaker 24 the appropriate information to a user of the mobile terminal 10. In an exemplary alternative embodiment the search module 68 may be internal to the camera module 36.

The search module 68 is also capable of enabling a user of the mobile terminal 10 to select from one or more actions in a list of several actions (for example in a menu or sub-menu) that are relevant to a respective POI, code-based data and/or OCR data and the like. For example, one of the actions may include but is not limited to searching for other similar POIs (i.e., supplemental information) within a geographic area. For example, if a user points the camera module at a historic landmark or a museum the mobile terminal may display a list or a menu of candidates (supplemental information) relating to the landmark or museum for example, other museums in the geographic area, other museums with similar subject matter, books detailing the POI, encyclopedia articles regarding the landmark, etc. As another example, if a user of the mobile terminal points the camera module at a bar code, relating to a product or device for example, the mobile terminal may display a list of information relating to the product including an instruction manual of the device, price of the object, nearest location of purchase, etc. Information relating to these similar POIs may be stored in a user profile in memory.

Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44 or access point (AP) 62. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (one shown in FIG. 2), visual search server 54 (one shown in FIG. 2), visual search database 51, or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or visual map server 54 may be coupled to the mobile terminal 10 via the Internet 50, SGSN 56 and GGSN 60. In this regard, devices such as the computing system 52 and/or visual map server 54 may communicate with the mobile terminal 10 across the SGSN 56, GPRS core network 58 and the GGSN 60. By directly or indirectly connecting mobile terminals 10 and the other devices (e.g., computing system 52, visual map server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), Wibree, infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like.

The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the visual search server 54, and/or any of a number of other devices, to the Internet 50, the mobile terminals 10 can communicate with one another, the computing system, 52 and/or the visual search server 54 as well as the visual search database 51, etc., to thereby carry out various functions of the mobile terminals 10, such as to transmit data, content or the like to, and/or receive content, data or the like from, the computing system 52.

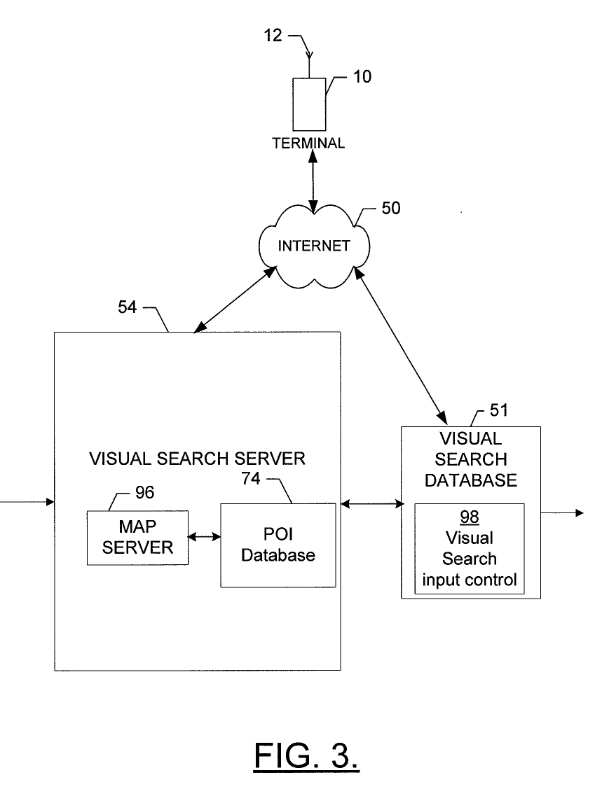

For example, the visual search server 54 may handle requests from the search module 68 and interact with the visual search database 51 for storing and retrieving visual search information. The visual search server 54 may provide map data and the like, by way of map server 96 as is disclosed in FIG. 3 and described in detail below, relating to a geographical area, location or position of one or more or mobile terminals 10, one or more POIs or code-based data, OCR data and the like. Additionally, the visual search server 54 may provide various forms of data relating to target objects such as POIs to the search module 68 of the mobile terminal. Additionally, the visual search server 54 may provide information relating to code-based data, OCR data and the like to the search module 68. For instance, if the visual search server receives an indication from the search module 68 of the mobile terminal that the camera module detected, read, scanned or captured an image of a bar code or any other codes (collectively, referred to herein as code-based data) and/or OCR data, for e.g., text data, the visual search server 54 may compare the received code-based data and/or OCR data with associated data stored in the point-of-interest (POI) database 74 and provide, for example, comparison shopping information for a given product(s), purchasing capabilities and/or content links, such as URLs or web pages to the search module to be displayed via display 28. That is to say, the code-based data and the OCR data, from which the camera module detects, reads, scans or captures an image, contains information relating to or associated with the comparison shopping information, purchasing capabilities and/or content links and the like. When the mobile terminal receives the content links (e.g. URL) or any other desired information such as a document, a television program, music recording, etc., it may utilize its Web browser to display the corresponding web page via display 28 or present the desired information in audio format via the microphone 26. Furthermore, the desired information may be displayed in multiple modes such as preview mode, best-matched mode and the user-select mode. In the preview mode the supplemental information and the preview of the supplemental information are displayed, wherein in the best-matched mode only the supplemental information that best matches the desired information is displayed and in the user select mode the supplemental information are displayed without the previews. Furthermore, the supplemental information may be transmitted, such as via email, to the user. Additionally, the visual search server 54 may compare the received OCR data, such as for example, text on a street sign detected by the camera module 36, with associated data such as map data and/or directions, via map server 96, in a geographic area of the mobile terminal and/or in a geographic area of the street sign. It should be pointed out that the above are merely examples of data that may be associated with the code-based data and/or OCR data and in this regard any suitable data may be associated with the code-based data and/or the OCR data described herein.

Additionally, the visual search server 54 may perform comparisons with images or video clips (or any suitable media content including but not limited to text data, audio data, graphic animations, code-based data, OCR data, pictures, photographs and the like) captured or obtained by the camera module 36 and determine whether these images or video clips or information related to these images or video clips are stored in the visual search server 54. Furthermore, the visual search server 54 may store, by way of POI database 74, various types of information relating to one or more target objects, such as POIs that may be associated with one or more images or video clips (or other media content) which are captured or detected by the camera module 36. The information relating to the one or more POIs may be linked to one or more tags, such as for example, a tag associated with a physical object that is captured, detected, scanned or read by the camera module 36. The information relating to the one or more POIs may be transmitted to a mobile terminal 10 for display.

The visual search database 51 may store relevant visual search information including but not limited to media content which includes but is not limited to text data, audio data, graphical animations, pictures, photographs, video clips, images and their associated meta-information such as for example, web links, geo-location data (as referred to herein geo-location data includes but is not limited to geographical identification metadata to various media such as websites and the like and this data may also consist of latitude and longitude coordinates, altitude data and place names), contextual information and the like for quick and efficient retrieval. Furthermore, the visual search database 51 may store data regarding the geographic location of one or more POIs and may store data pertaining to various points-of-interest including but not limited to location of a POI, product information relative to a POI, and the like. The visual search database 51 may also store code-based data, OCR data and the like and data associated with the code-based data, OCR data including but not limited to product information, price, map data, directions, web links, etc. The visual search server 54 may transmit and receive information from the visual search database 51 and communicate with the mobile terminal 10 via the Internet 50. Likewise, the visual search database 51 may communicate with the visual search server 54 and alternatively, or additionally, may communicate with the mobile terminal 10 directly via a WLAN, Bluetooth, Wibree or the like transmission or via the Internet 50.

In an exemplary embodiment, the visual search database 51 may include a visual search input control/interface 98. The visual search input control/interface 98 may serve as an interface for users, such as for example, business owners, product manufacturers, companies and the like to insert their data into the visual search database 51. The mechanism for controlling the manner in which the data is inserted into the visual search database 51 can be flexible, for example, the new inserted data can be inserted based on location, image, time, or the like. Users may insert bar codes or any other type of codes (i.e., code-based data) or OCR data relating to one or more objects, POIs, products or the like (as well as additional information) into the visual search database 51, via the visual search input control/interface 98. In an exemplary non-limiting embodiment, the visual search input control/interface 98 may be located external to the visual search database 51. As used herein, the terms “images,” “video clips,” “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing system 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

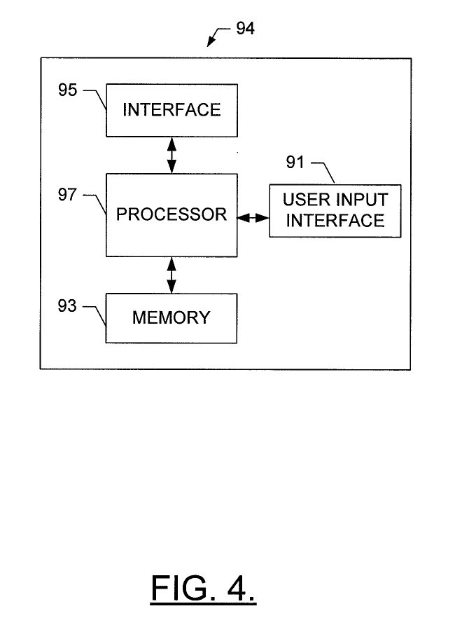

Referring to FIG. 4, a block diagram of a server 94 is shown. As shown in FIG. 4, server 94 (which may function as, or include, one or more of visual search server 54, POI database 74, visual search input control/interface 98, visual search database 51) is capable of allowing a product manufacturer, product advertiser, business owner, service provider, network operator, or the like to input relevant information (via the interface 95) relating to a target object for example a POI, as well as information associated with code-based data and/or information associated with OCR data, (for example merchandise labels, web pages, web links, yellow pages information, images, videos, contact information, address information, positional information such as waypoints of a building, locational information, map data encyclopedia articles, museum guides, instruction manuals, warnings, dictionary, language translation and any other suitable data), for storage in a memory 93.

The server 94 generally includes a processor 97, controller or the like connected to the memory 93, as well as an interface 95 and a user input interface 91. The processor can also be connected to at least one interface 95 or other means for transmitting and/or receiving data, content or the like. The memory can comprise volatile and/or non-volatile memory, and is capable of storing content relating to one or more POIs, code-based data, as well as OCR data as noted above. The memory 93 may also store software applications, instructions or the like for the processor to perform steps associated with operation of the server in accordance with embodiments of the present invention. In this regard, the memory may contain software instructions (that are executed by the processor) for storing, uploading/downloading POI data, code-based data, OCR data, as well as data associated with POI data, code-based data, OCR data and the like and for transmitting/receiving the POI, code-based, OCR data and their respective associated data, to/from mobile terminal 10 and to/from the visual search database as well as the visual search server. The user input interface 91 can comprise any number of devices allowing a user to input data, select various forms of data and navigate menus or sub-menus or the like. In this regard, the user input interface includes but is not limited to a joystick(s), keypad, a button(s), a soft key(s) or other input device(s).

The system architecture can be configured in a variety of different ways, including for example, a mobile terminal device 10 and a server 94; a mobile terminal device 10 and one or more server-farms; a mobile terminal device 10 doing most of the processing and a server 94 or one or more server-farms; a mobile terminal device 10 doing all of the processing and only accessing the servers 94 to retrieve and/or store data (all data or only some data, the rest being stored on the device) or not accessing the servers at all, having all data directly available on the device; and several terminal devices exchanging information in an ad-hoc manner.

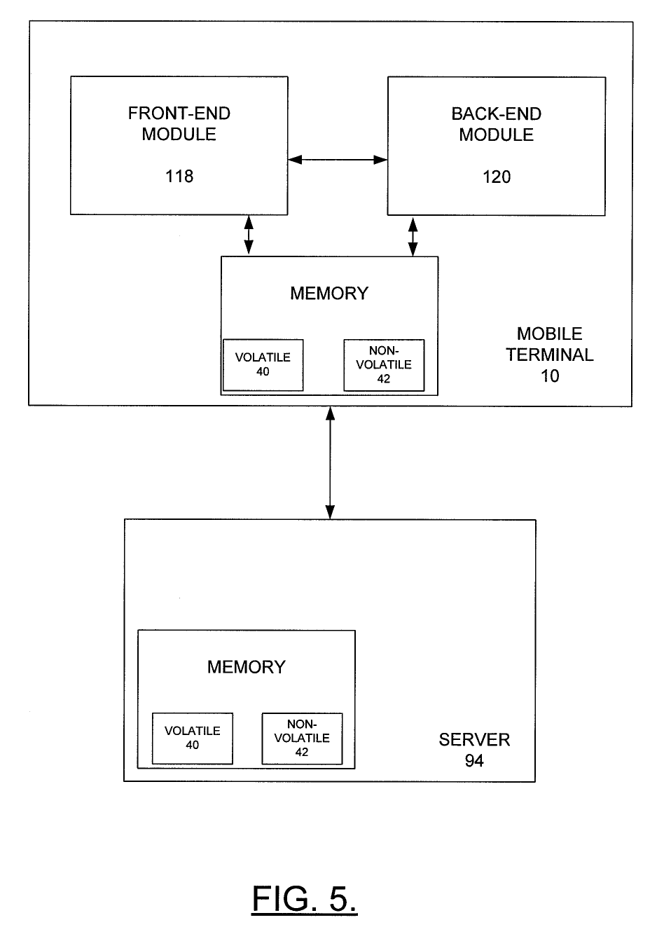

According to the system architecture as disclosed in FIG. 5 and described in detail below, the mobile terminal device 10 may host both a front-end module 118 and a back-end module 120, each of which may be any means or device embodied in hardware or software or a combination thereof for performing the respective functions of the front-end module 118 and the back-end module 120, respectively. The front-end module 118 may handle interactions with the user of the mobile terminal (i.e. keypad 30, display 28, microphone 26, and speaker 24) and communicates user requests to the back-end module 120 (i.e. controller 20, memory 40, 42, camera 36 and search module 68). The backend module 120 may perform most of the back-end processing as discussed above, while a backend server 94 performs the rest of the back-end processing. Alternatively, the back-end module 120 may perform all of the back-end processing, and only access the server 94 to retrieve and/or store data (all data or only some data, rest being stored in terminal memory 40, 42). Yet, in another configuration (not shown), the back-end module 120 may not access the servers at all, having all data directly available on the mobile terminal 10.

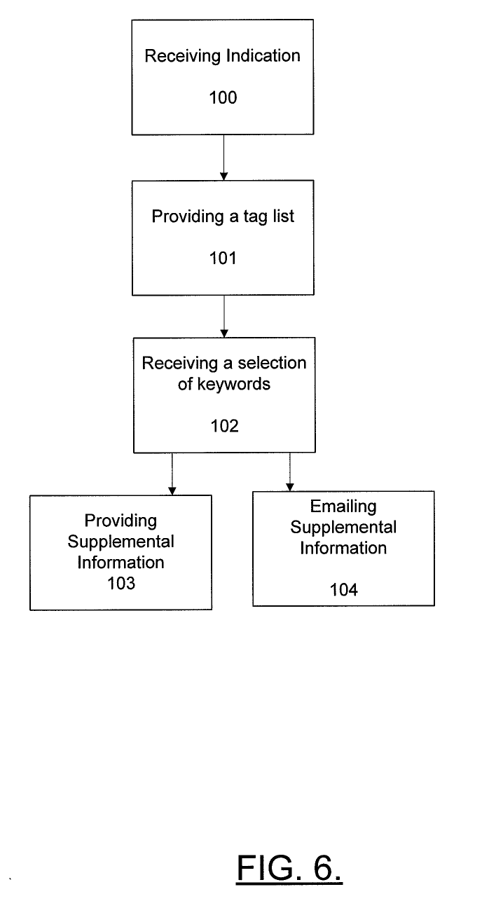

It should be understood that each block or step of the flowcharts, shown in FIG. 6, and combination of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or server and executed by a built-in processor in the mobile terminal or server. As will be appreciated, any such computer program instructions may be loaded onto a computer or other programmable apparatus (i.e., hardware) to produce a machine, such that the instructions which execute on the computer or other programmable apparatus (e.g., hardware) means for implementing the functions implemented specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the functions specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As described in FIG. 6, an exemplary method of providing supplemental information related to on object in an image may include receiving an indication of an image including an object at operation 100. The indications of the image may, for example, correspond to a captured image or an image in a field of view of a camera. At operation 101, a tag list associated with the object in the image may be provided. The tag list may include at least one tag. A selection of a keyword from the tag list may be received at operation 102. The method may further include providing supplemental information based on the selected keyword at operation 103. In an exemplary embodiment, an optional operation 104 of emailing the keyword and the supplemental information to an identified email recipient may be performed subsequent to operation 103 or instead of operation 103. It should be understood that the operations described with respect to FIG. 6 may be executed by a processing element of either of a mobile terminal or a server.

In one embodiment, operation 103 may include providing a web site, a document, a television program, a radio program, music recording, a reference manual, a book, a newspaper article, a magazine article or a guide as the supplemental information. Alternatively, the supplemental information may include an encyclopedia article related to the selected keyword. The supplemental information may be provided in either audio or visual format.

In one exemplary embodiment, the supplemental information may be provided such that a preview of a portion of each of a plurality of documents comprising the supplemental information is presented. Alternatively, a preview of information associated with a highlighted document may be provided. As yet another alternative, the supplemental information may be presented in a list from which the user may select a keyword without being presented with a preview. In another exemplary embodiment, only a best-matched result based on a ranking of results of a search for the supplemental information may be presented to the user. The search may have been made based on the selected keyword.

In another exemplary embodiment, the method may include receiving a selection of a particular item among a list of items comprising the supplemental information and rendering the particular item and information indicative of other objects proximate to the object in the image within a predefined distance. As such, for example, embodiments of the present invention may be useful as a mobile tour or museum guide in which the user may scan or capture an image of an object corresponding to a landmark or museum exhibit. The landmark or exhibit may be identified by visual search (e.g., using source images stored in a server associated with the tour or museum) and corresponding keywords associated with the may be identified and/or displayed such as in a tag list. The user may be presented with the keywords in a list format for selection of supplemental information to be provided to the user. Alternatively or additionally, auxiliary information related to the keywords or other objects, landmarks, exhibits, etc., within a predefined distance may also be provided. In exemplary embodiments, an encyclopedia article (e.g., perhaps customized by the museum's curator) may be provided, or use of the email functionality described above may offer an opportunity for tracking of a tour to be performed on a personal computer of the user. In yet another alternative embodiment, online instruction manuals may be provided on the basis of device scans associated with parts, machines or conditions noted in remote locations. Instructions, drug information sheets, or other information may therefore be provided to the user based on selected keywords related to an identified object.

In some instances, in order to avoid using the display (e.g., for the performance of a task requiring visual attention elsewhere) audible instructions may be provided as the supplemental or auxiliary information. Furthermore, certain identified objects may be mapped to particular supplemental information or articles. For example, a company logo may be mapped to articles about the corresponding company; a historic landmark may be mapped to articles describing a history of the historic landmark; a landmark may be mapped to articles about the landmark or the city in which the landmark is located; a book or work of art may be mapped to articles about the author or artist and/or related works; a country flag may be mapped to articles about the corresponding country or to a function of switching the language of articles presented based on a language associated with the country flag; a distinguished individual may be mapped to a corresponding articles about the individual; technical devices may be mapped to corresponding instruction manuals; medical drugs may be mapped to corresponding drug information sheets; movie posters or gadgets may be mapped to articles about the actors, the movie or related movies; etc. Articles could be, for example, encyclopedia articles describing the keyword or trivia questions about the keyword or object.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of an image including an object;
providing a tag list associated with the object in the image, the tag list comprising at least one tag;
receiving a selection of a keyword from the tag list; and
providing supplemental information based on the selected keyword.

2. The method of claim 1, wherein providing the supplemental information comprises providing a web site, a document, a television program, a radio program, music recording, a reference manual, a book, a newspaper article, a magazine article or a guide.

3. The method of claim 1, wherein providing the supplemental information comprises providing an encyclopedia article related to the selected keyword.

4. The method of claim 1, wherein providing the supplemental information comprises providing information in either audio or visual format.

5. The method of claim 1, wherein providing the supplemental information comprises providing a preview of a portion of each of a plurality of documents comprising the supplemental information.

6. The method of claim 1, wherein providing the supplemental information comprises providing only a best-matched result based on a ranking of results of a search for the supplemental information, the search being made based on the selected keyword.

7. The method of claim 1, further comprising receiving a selection of a particular item among a list of items comprising the supplemental information and rendering the particular item and information indicative of other objects proximate to the object in the image within a predefined distance.

8. The method of claim 1, wherein providing supplemental information further comprises emailing the keyword and the supplemental information to an identified email recipient.

9. The method of claim 1, wherein receiving the indication of the image comprises receiving indications of a captured image or an image in a field of view of a camera.

10. An apparatus, comprising a processing element configured to:
receive an indication of an image including an object;
provide a tag list associated with the object in the image, the tag list comprising at least one tag;
receive a selection of a keyword from the tag list; and
provide supplemental information based on the selected keyword.

11. The apparatus of claim 10, wherein the processing element is further configured to retrieve a web site, a document, a television program, a radio program, music recording, a reference manual, a book, a newspaper article, a magazine article or a guide.

12. The apparatus of claim 10, wherein the processing element is further configured to provide an encyclopedia article related to the selected keyword.

13. The apparatus of claim 10, wherein the processing element is further configured to provide a preview of a portion of each of a plurality of documents comprising the supplemental information.

14. The apparatus of claim 10, wherein the processing element is further configured to provide only a best-matched result based on a ranking of results of a search for the supplemental information, the search being made based on the selected keyword.

15. The apparatus of claim 10, wherein the processing element is further configured to receive a selection of a particular item among a list of items comprising the supplemental information and rendering the particular item and information indicative of other objects proximate to the object in the image within a predefined distance.

16. The apparatus of claim 10, wherein the processing element is further configured to email the keyword and the supplemental information to an identified email recipient.

17. A computer program product comprising at least one computer-readable storage medium having computer-readable program code portions stored therein, the computer-readable program code portions comprising:
a first executable portion for receiving an indication of an image including an object;
a second executable portion for providing a tag list associated with the object in the image, the tag list comprising at least one tag;
a third executable portion for receiving a selection of a keyword from the tag list; and
a fourth executable portion for providing supplemental information based on the selected keyword.

18. The computer program product of claim 17, wherein the fourth executable portion includes instructions for providing a web site, a document, a television program, a radio program, music recording, a reference manual, a book, a newspaper article, a magazine article or a guide.

19. The computer program product of claim 17, wherein the fourth executable portion includes instructions for providing an encyclopedia article related to the selected keyword.

20. The computer program product of claim 17, wherein the fourth executable portion includes instructions for providing a preview of a portion of each of a plurality of documents comprising the supplemental information.

21. The computer program product of claim 17, wherein the fourth executable portion includes instructions for providing only a best-matched result based on a ranking of results of a search for the supplemental information, the search being made based on the selected keyword.

22. The computer program product of claim 17, further comprising a fifth executable portion for receiving a selection of a particular item among a list of items comprising the supplemental information and rendering the particular item and information indicative of other objects proximate to the object in the image within a predefined distance.

23. The computer program product of claim 17, wherein the fourth executable portion includes instructions for emailing the keyword and the supplemental information to an identified email recipient.

24. An apparatus comprising:
means for receiving an indication of an image including an object;
means for providing a tag list associated with the object in the image, the tag list comprising at least one tag;
means for receiving a selection of a keyword from the tag list; and
means for providing supplemental information based on the selected keyword.

25. The apparatus of claim 24, wherein means for providing the supplemental information comprises means for providing an encyclopedia article related to the selected keyword.
